(19) United States
(12) Patent Application Publication
(10) Pub. No.: US 2007/0248743 A1
(43) Pub. Date: Oct. 25, 2007

(54) Food processing apparatus and method

(76) Inventors: Jon Pullin, Arlington, TX (US); Luke B. Rainbolt, Weatherford, TX (US); Bill Marshall, Fort Worth, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 11/407,609

(22) Filed: Apr. 20, 2006

(51) Int. Cl. A23L 1/31

(52) U.S. Cl. 426/646

(57) ABSTRACT

A process for preparing pepperoni, includes the steps of preparing the meat mixture by grinding and mixing to specification. The sausage is stuffed into casings or is extruded into sheet form for fermentation and cooking, following cooling and slicing or dicing. The resulting product is dried in a perforated drum dryer where it is exposed to a relatively warm forced air stream which dries and also assists in conveying the product through the dryer. The dried sausage is then typically passed to a chiller or freezer.

### BACKGROUND OF THE INVENTION

1. Field of the Invention

The present invention relates generally to the preparation of food products such as sausage products, and more specifically to a method and apparatus for preparing pepperoni wherein a cooked sausage is dried using a perforated cylinder apparatus and method.

2. Description of the Prior Art

A variety of techniques have been used in the prior art to manufacture cured, smoked, dried and semi-dried sausages. Pepperoni is one product manufactured from cooked and dried sausage. In some of the prior art processes, the initial meat mixture is cured and thereafter dried or heated in air, in sunlight, in drying rooms or smokehouses, or the like. The curing time or drying time in many of the older processes, as well as in some of the current processes, typically extended for many hours, or even days or weeks. A wide variety of final products and qualities result from the use of age-old recipes in the known manufacturing processes. However, decreasing the drying time in such processes would add to the efficiency of the processes, making them more economical to practice.

Pepperoni is typically prepared by stuffing the desired meat mixture into casings and fermenting and drying the resultant product for extended periods. This particular type of sausage is most commonly served in thin slices, with or without the casing, the casing being removed after cooking if it is removed at all. Pepperoni pizzas containing sliced pepperoni toppings, for example, are sold by most pizza producers throughout the world.

One prior art attempt at reducing the time required for the preparation of such sausage products is described in U.S. Pat. No. 2,346,232 issued Apr. 11, 1944 to Pirai, et al. for “Meat Process”. In this patent, semi-dried meat for food ration purposes is prepared in shorter periods than were previously required, by exposing the meat mixture to a turbulent air flow to reduce the moisture content from an original 45-85% to 20-55%. The air used in this process is at a temperature of about 3-30° C. and the air is moved across the meat surface at a velocity of 1-18 feet/second. The meat products discussed in this patent are produced in 1/41-1¼ inch thick layers or in ropes of ⅜-inch diameter for drying. For ⅜-inch ropes, drying is accomplished to 28% in about 8-13 hours, while the 1¼-inch layers require 13 days, still a relatively short period when compared to earlier processes. The benefits of turbulent flow are said to be increased by 40% early in the process where the air contacts a moist surface. The product is held in flat trays in the examples of the patent.

Another process for preparing sausages is disclosed in U.S. Pat. No. 3,482,996 issued Dec. 9, 1996 to Christianson, et al. for “Process for Preparing Dry and Semi-Dry Sausages”. In this patent, the meat compositions include dehydrated, spun, edible protein fibers or dehydrated fibrous products derived from spun, edible protein fibers to substantially reduce drying time. The fibers allegedly take up the moisture which is typically removed in the drying room.

U.S. Pat. No. 4,265,918, issued to Kueper, et al. on May 5, 1981, discusses a food processing technique which includes immersion of the meat product in a curing solution, followed by vacuum dehydration. The initial hydration step is to about 105-125% of the products' original weight, followed by vacuum treatment to reduce the overall product weight to 70-95% of its original weight. The process is especially well suited for sliced meat products, like bacon.

U.S. Pat. No. 4,279,935 issued Jul. 21, 1981, to Kentor, for “Dry Sausage Processing With Added Acid”, describes a process in which bactericides and bacteriostats are first added to the meat, followed by treatment with an acidic mixture to reduce the pH to about 5.7. The sausage is then heated to at least 58° C. and control dried to reduce the average moisture level to about 35%. The drying time is on the order of 5-20 days.

Another process for producing semi-dry sausage products, including pepperoni, is disclosed in U.S. Pat. No. 5,736,186 issued Apr. 7, 1998 to Holdren and entitled “Process For Producing Dry And Semi-Dry Sausage Products”. In this patent, the process comprises mixing the basic meat ingredients and adding an encapsulated acidulant which has a melting point above 90° F. The product is formed into sausage shaped products in which the product has at least one cross-sectional dimension no greater than 1.0 inch. The raw meat and encapsulated acidulant are then heated for a time sufficient to melt the encapsulating material and to dehydrate the product to reduce the moisture-to-protein ratio to no greater than 3.7 to 1. The heating step is carried out in very short periods of time, at high temperatures in the range of 90-500° F., with the higher temperatures being used for the shortest drying times.

In addition to the above described prior art, spiral type conveyor equipment has also been used in the past in a variety of food preparation processes, including the preparation of pepperoni. In such equipment, a food product may be frozen or heated as it moves along a conveyor which forms a number of tiers or levels within a spiral system.

For example, U.S. Pat. No. 5,942,265, issued Aug. 24, 1999, to Roberds et al., and its continuation-in-part, U.S. Pat. No. 6,524,633, issued Feb. 25, 2003, both describe a process for preparing diced or sliced pepperoni which is dried by passing the cooked sausage to a spiral drier were is exposed to air at about 50-120° F. at an initial humidity of 50% or less, under turbulent air flow.

U.S. Pat. No. 6,630,194, assigned to Hormel, discusses a method of making pepperoni flakes which includes the use of fat raw materials and an emulsifier to reduce the fat particle size, and a moisture protein ratio of 1.6:1 or less in the end product. The specification of the patent refers to drying by conveying the product through a “drum dryer.” As Applicant's understand this type of process, product is supplied to a flow path between a pair or rotating drums. The distance between the drums is on the order of 0.6 to 0.25 mm in the '194 patent. The drum dryer cooks the product and removes moisture.

U.S. Pat. No. 5,639,495, describes a method for making pepperoni sausage in which an added protein component is utilized in the sausage mixture to improve the performance of the resulting product. In this case, the sausage appears to be dried in a traditional drying room (column 4, line 58).

U.S. Pat. Nos. 5,736,186 and 6,004,592, both assigned to Doskocil, teach processes for making pepperoni sausage. In the '592 patent, an added protein is utilized to improved the performance of the resulting product. The mixture also includes a starter culture of lactic acid bacteria. The dry sausage is placed in a drying room (col. 5, line 8). In the '186 patent, ground meat is mixed with an acidulent. The acid lowers the pH of the product during processing. The '186 also describes a heating step, generally at column 11 of the patent in which the product passes through a gas fire on a perforated belt.

Patent Publications Nos. 2003/0031882 and 2004/00047975 are related patent publications which disclose a method of making pepperoni flakes including the use of fat raw material and an emulsifier.

The above described processes represent advances in the known state of the art of preparing sausage foodstuffs. Nevertheless, a need continues to exist for improvements in the overall quality and steps involved in manufacturing of dry or semi-dry sausages.

A need particularly continues to exist for improvements made in connection with processes for manufacturing pepperoni, especially the type of pepperoni which is to be used in large quantities for the manufacture of pizzas.

A particular need exists for improvements in the drying step or steps involved in present commercial practiced manufacturing processes for the manufacture of sausage products such as pepperoni.

### SUMMARY OF THE INVENTION

The present invention has as one object to provide an improved manufacturing process for preparing and drying pepperoni.

Another feature of the present invention is the preparation of pepperoni in a minimal amount of time by shortening the drying time normally required in the industry as practiced at the present time.

A further object of the present invention is to employ a novel perforated drum dryer and drying step for drying pepperoni which has been previously fermented and cooked and subsequently subdivided into sliced or diced pieces.

The exact preferred apparatus and method for practicing the invention will be described in the Detailed Description which follows. However, the invention generally begins with a process which first includes manufacturing cooked pepperoni in conventional fashion. This process comprises formulating a meat mixture to the desired specification and grinding the meat, such as beef and/or pork, to a size on the order of about ½ inch or less. The meat is then mixed with traditional additives such as salt, culture, water and spices, oleoresins, dextrose, and the like. The mixture is typically blended, followed by a second grinding which provides a product having a size no greater than about 3/16 inch. At this point, the prepared meat mixture may be placed into casings for fermentation and cooking, using times and using temperatures which are standard in the relevant industry. The cooked sausage will typically thereafter be chilled, following which the cooked, chilled meat mixture is preferably sliced. If a casing has been used during the fermentation and cooking step, the casing may be removed or left on as desired by the end user. The preferred sausage for purposes of the present invention is pepperoni sausage.

The cooked sausage, which has been manufactured in the conventional manner described, is preferably sliced and then dried in a special perforated drum dryer where the temperature and humidity of the air flow within the perforated drum is controlled. The pepperoni may be exposed to drying zones of varying temperature and humidity. For a typical example, in a first zone having a length on the order of 10 feet, the sliced pepperoni may contact air at a temperature of less than about 40° F. and 20% humidity. In a second zone of, for example 30 feet in length, the pepperoni may contact air at a temperature less than about 70° F. and 10% humidity. The drum rotates about a horizontal axis with air being introduced at one or more positions below the perforated drum by means of a supply plenum. The air flows upwardly and is recovered in a return plenum. The return plenum preferably includes a station with refrigeration coils which remove humidity picked up by the air and where water is condensed for disposal. The air is recycled in a closed system through a heating station, for example employing steam coils, where the air is heated in its dry condition and reintroduced to the bottom of the perforated drum. While in the dryer, moisture in the meat product is reduced to a ratio of about 1.6:1 or less with respect to protein. The pepperoni may then be conveyed to a chiller, where it is chilled or frozen for packaging and subsequent transfer to the customer or pizza preparation line.

Additional objects, features and advantages will be apparent in the written description which follows.

### BRIEF DESCRIPTION OF THE DRAWINGS

FIG. 1 is a simplified, schematic view of the perforated drum dryer and associated equipment used to carry out the steps of the preferred form of the present invention as described and claimed in the accompanying detailed description; and

FIG. 2 is a partial, schematic view of one form of the perforated drum of the invention, showing the internal flights and various temperature zones.

### DETAILED DESCRIPTION OF THE INVENTION

The present invention deals primarily with improvements in the drying step or steps used in the conventional process for manufacturing sliced and diced sausage, and particularly pepperoni sausage. The beginning steps in the manufacturing process of the invention employ the conventional processes of blending, stuffing the meat mixture into casings, curing and cooking the meat mixture following which the product is thinly sliced. The improvements of the present invention are directed to the drying step or steps which occur prior to, for example, placing the thin slices on top of a pizza for packaging.

Because the prior art drying processes have typically required from several days to several weeks, production capacity for a manufacturing facility is limited by the amount of space allocated to the drying process. The process is capital intensive, and requires a tremendous amount of product to be held in drying rooms at any given time. Accordingly, a method of manufacturing pepperoni that overcomes these disadvantages would be a significant advance in this industry.

The convention steps of preparing the cooked and sliced sausage will be familiar to those skilled in the art. As a general overview, it will be appreciated that the particular meat mixture, including spices, flavorings, salt, cultures and the like can be widely varied by those skilled in the art, and no particular sausage formulation is being claimed herein. Similarly, while particular grind sizes will be referred to for various stages of the process, these sizes can also be varied by those skilled in the art who would also appreciate the corresponding need for further process modifications, for example in connection with times and temperatures.

Also, certain ranges may be given for the humidity, temperature, drying time, and air flow characteristics for the most preferred embodiment, based again on the particular volumes desired, space requirements and other needs. Those skilled in the art will appreciate that the selection of optimum numbers for these variables can be made once the plant and overall process parameters of a particular processing installation are known. Certain preferred systems are disclosed herein for controlling the temperature and the humidity of the air conveyed to and removed from the dryer. These also can be varied by substituting, for example, chemical for mechanical systems or open versus closed heating/cooling systems, depending on normal plant considerations of energy cost, plant lay-out and the like, since the temperature and humidity values used in the process tolerate some ongoing variability due to, for instance, changes in ambient plant temperatures and humidity and other related factors.

It will also be appreciated by those skilled in the relevant arts that, while the present invention has as its principal object the manufacture of pepperoni, it could be used for the manufacture of other dry or semi-dry sausage products and could be readily adapted with regard to drying times, temperatures and air humidities by one skilled in the art after the present specification has been read.

Proceeding now to a description of the most preferred embodiment, the first step of the process is the formulation of the meat mixture (e.g. beef, pork, poultry, etc.) to the desired specification, including the specification for fat. These specifications may be established by the processor or the customer. Initially, the meat is course ground as is well known in the pepperoni industry. In most cases this will be to a size no greater than about ½ inch.

The formulated meat is next placed into a blender where it is mixed with the desired salt, culture, water and spices, including any specified oleoresins, and dextrose. Further detail is not required here, as the recipe or formulation in and of itself does not form part of the present invention. As is the case with current practice, the blender may operate for about five minutes to thoroughly mix the ingredients.

Following blending, the meat mixture is passed through a final grinder, where it is reduced to a size no greater than about 3/16″. A bone elimination system may be used here, if bone has not been eliminated earlier in the process. When the meat mixture exits the final grind station, it will generally be at about 40° F. or less in temperature.

The next step in the process is to prepare the meat mixture for fermentation and cooking, either by stuffing it into casings, typically about 1 to 4 inches in diameter and approximately 4 feet in length, or to mechanically extrude the mixture onto screens. In the discussion which follows, it is assumed that the mixture is extruded onto screens, it being understood that a casing process may just as easily be employed for the fermentation, cooking, cooling, slicing and dicing steps which are described.

In one form of commercial extrusion process, the sausage is extruded in sheets about two to four inches in depth and up to twelve inches in width by thirty-six inches in length. The sheet size, including depth can be varied, with corresponding changes in the cooking and fermenting parameters discussed. The racks are transferred to ovens where fermentation takes place, with the sausage temperature preferably held at around 100° F. for twelve to eighteen hours. Air temperature accordingly should be kept at about 90°-110° F. In a subsequent cooking step for 3-4 hours at about 140° F., the internal temperature of the sausage is raised to 128° F. or higher for an hour or longer, preferably to above about 136° F. for an hour.

The cooked sausage is then cooled to an internal temperature of 35° F. or less. The cooled sausage is sliced or sliced and diced. If slicing alone is employed, about a 1/16 inch thick slice is preferred. The size is not to be deemed as limiting the scope of the invention. For example, the slice or dice size could be ¼ inch or ⅜ inch, if desired.

The previously described process for the manufacture of cooked sausage is one form of conventional process which is practiced commercially in the relevant industry. Applicant's invention is concerned with the drying step or steps which follow the previously described meat blending, extruding and cooking steps. In the present invention, after slicing or slicing and dicing, the meat is passed to a special perforated drum dryer, the details of which will now be described.

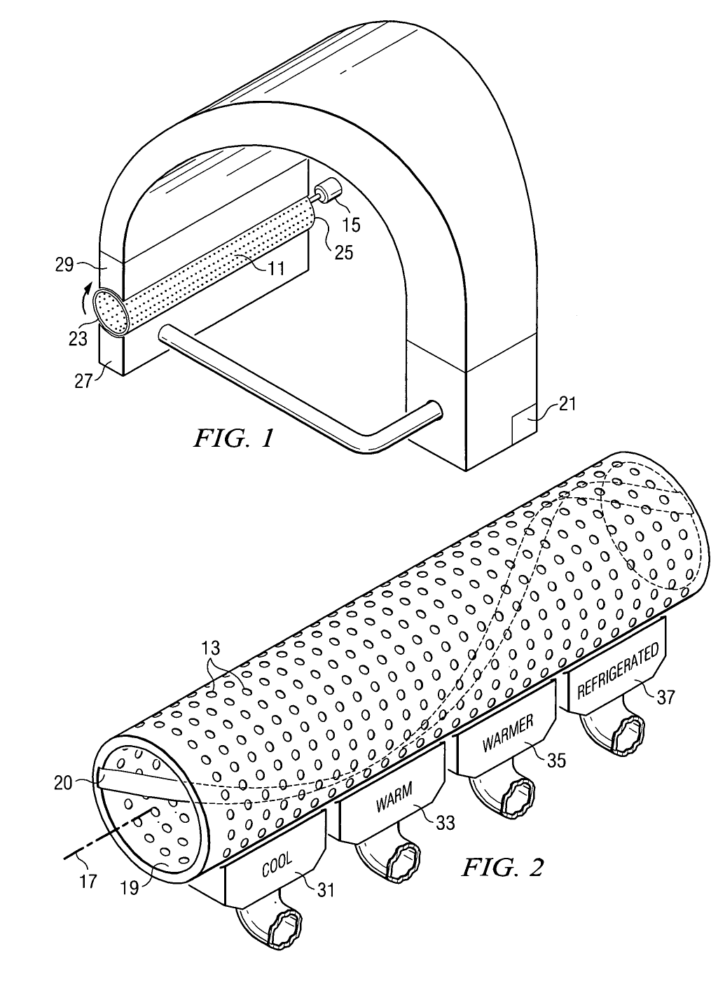

With reference to FIG. 1 of the drawings, there is shown a perforated drum dryer 11 having perforations (13 in FIG. 2) in the sidewalls thereof and an associated drive mechanism (illustrated as 15 in FIG. 1) for rotating the drum dryer about a generally horizontal axis 17. In one preferred embodiment of the invention, the cylinder drum is approximately 6 feet in diameter and 40 feet in length. The cylinder perforations are on the order of ⅛ to ¼ inch with the smooth side of the perforations being turned in toward the initially open interior 19 of the cylinder drum.

The initially open interior 19 of the cylinder drum may be smooth or may be provided with appropriate flighting such as the spiral shaped flighting shown as 20 in FIG. 2. The flighting can be, for example, on 12 inch centers and be at least about 2 inches tall in one embodiment of the design. The actual shape of the flighting, if employed, can take a variety of shapes including, for example, longitudinal strips, curved hook shaped elements, etc.

The drive mechanism can be any conventional mechanism for turning the cylinder about the horizontal axis 17. For example, a suitable belt drive or gear drive mechanism can be employed. Heavy duty drive mechanisms are known in the cement and kiln industries for turning cylindrical reactor vessels about a horizontal axis. Other commercially available drives will be familiar to those skilled in the relevant arts.

A source of forced air from a conventional blower located in a blower enclosure 21 associated with the dryer 11 causes the slices of pepperoni to rise, fall and tumble within the dryer interior between an entrance point 23 and an exit point 25, thereof. The pepperoni might be fed to the entrance 23 and passed from the exit 25 on a conveyor belt (not shown) or other suitable conveyance means. Conditioned air from the forced air source is passed into and through the interior of the drum dryer to thereby convey the sausage through the cylinder drum for a time sufficient to produce dried sausage having a moisture content below a predetermined level. For example, the sausage is preferably dried to a final moisture content producing a ratio of moisture to protein of approximately 1.6:1 for pepperoni sausage. The supply plenum 27 can be fed by booster blowers which act to fluidize the pepperoni stream within the dryer drum 11.

Preferably, the source of forced air enters a lower portion of the drum dryer such that the sausage and air move through the dryer in a generally vertical direction, whereby the conditioned air removes moisture from the sausage and changes in temperature as it moves upwardly through the dryer and exits the dryer at an upper portion thereof. The air temperature change varies over the various “zones” to be described with the temperature rising in the first part of the process, dropping in the “mid zone”, and in rising the last zone before refrigeration. The refrigeration zone, if present, would show an air temperature rise as product moves through the process.

Movement of product can be accomplished by providing the source of forced air as a lower supply plenum 27 (FIG. 1) and an upper return plenum 29. In this way, a bottom half of the cylinder drum is exposed to conditioned air from the supply plenum 27 and the respective upper half of the cylinder drum is at least partly covered by the return plenum 29.

Preferably, there are at least two primary zones or ducts within the cylinder drum created by the supply plenum. For example, the first zone might be on the order of 10 feet long with the air temperature being less than 40° F. and humidity of 20%. The second zone might be on the order of 30 feet long with the air temperature being less than about 70° F. and humidity 10%. However, it will be understood that, as schematically shown in FIG. 2, the lower supply plenum may be arranged as a series of air ducts such as the cool air duct 31, the warm duct 33, the warmer duct 35 and the refrigeration duct 37. The chilling or refrigeration cylinder or zone will typically have an air temperature of about −20° F. and may be 10 feet in length and of similar to the primary drying zones previously described.

In prototype tests, temperature and humidity were altered during the test period of 30 minutes in a single zone rotating drum dryer. Best results were achieved with cold (40° F.) air at low humidities (15%) for 10 minutes and then warmer (65° F.) air with lower humidity of 10%. Optimally, the perforated drum dryer of the invention is used to reduce the amount of moisture contained in the diced or sliced product, from initial levels on the order of 50% to a final moisture content producing a ratio of moisture to protein of 1.6:1.

A large capacity air-handling system could be used to supply air to the supply plenum. In some embodiments of the invention, several plenum chambers may be employed. Such a system would typically utilize variable or fixed speed fans located adjacent the dryer or within the supply plenum, the fan pushing air through the drum at air velocities on the order of as much as 750 feet/minute or more. The air which is exposed to the product in the drum picks up moisture as the product dries. At the top of the cylinder drum, the air will have lost a certain amount of its heat content when compared to the inlet temperature and have an increased relative humidity. The air passing over the product will change in temperature and moisture content dependent in part, upon the condition of the product it contacts. The air exiting the top of the cylinder drum is collected in the return plenum which makes up a part of a closed air flow system. The return air can be, for example, passed over ammonia cooled refrigeration coils and chilled to 32° F. to condense water from the return air, the water being collected for disposal. As mentioned previously other systems for removing the water, such as the use of chemical desiccants or other chemicals can be used in place of chillers, but such systems are typically more expensive than using refrigeration equipment which is known and widely available.

Returning to the overall process characteristics, the dried pepperoni can be conveyed from the perforated drum dryer to a freezing tunnel or other system for chilling or freezing the product for packaging or otherwise transferred for use with a particular final product, such as pizza. Preferably, the perforated drum is extended for 10 or more feet, with this section of the apparatus being supplied with −20° F. air, as has been described schematically with respect to FIG. 2. While drying can be completed in about ¼ hour to about 1½ hours, the time required for freezing or chilling the product, preferably to less than about 35° F., will be dependent upon the length of the freezer tunnel, the temperatures maintained therein and conveyor speeds.

By the use of the dryer of the invention, overall processing time for making pepperoni is dramatically reduced. Consistent, evenly-dried product also is produced. Substantial processing time, and the costs associated therewith are reduced using a system which occupies relatively little plant space and which is highly reliable.

Now that the equipment and the processes have been described in sufficient detail to enable one skilled in the art to practice the preferred form of the invention, it will be even more apparent how variations of time, temperature and humidity can be made by those skilled in the art to take into account a particular processing environment. For example, relatively more heat must be added to the air flow in colder climates. On the other hand, if processing were to take place in humid, warm environments, such as the southern part of the United States, especially during the summer months, additional refrigeration capacity might be needed to lower humidity to a level of less than 30%. It might also be necessary to maintain the air in a cooled condition downstream of the refrigeration coils if ambient temperatures are excessive.

Thus, while the invention has been shown in several of its embodiments to illustrate the principles of the invention, it is not limited thereby but is susceptible to various changes and modifications as have been suggested herein without departing from the spirit thereof.

I claim:

1. A process for preparing sausage comprising the steps of:
preparing a combination of meat ingredients, mixing and fermenting the combination of ingredients, followed by cooking the resulting mixture for a preselected time and at a preselected temperature to form a sausage;
cooling the cooked sausage to a temperature sufficiently low to permit slicing;
slicing the sausage to form sausage slices;
feeding the sausage slices to a perforated drum dryer having perforated sidewalls and having an associated drive mechanism for rotating the drum dryer about a generally horizontal axis, the dryer having an exterior and a generally cylindrical interior and a source of forced air associated with the dryer which cause the slices to rise, fall and tumble within the dryer interior between an entrance point and an exit point thereof;
causing the drum dryer to rotate about the horizontal axis;
passing conditioned air from the source of forced air into and through the interior of the drum dryer to thereby convey the sausage through the drum dryer for a time sufficient to produce dried sausage having a moisture content below a predetermined level.

2. The process of claim 1, wherein the sausage is dried to a final moisture content producing a ratio of moisture to protein of approximately 1.6:1.

3. The process of claim 1, wherein the sausage and conditioned air enter a lower portion of the drum dryer such that the sausage and air move through the dryer in a generally vertical direction, whereby the conditioned air removes moisture from the sausage and drops in temperature as it moves upwardly through the dryer and exits the dryer at an upper portion thereof.

4. The process of claim 3 wherein the sliced sausage is diced before it enters the dryer.

5. The process of claim 1, wherein the drum dryer source of forced air comprises a lower supply plenum and an upper return plenum, a bottom half of the cylinder drum being exposed to conditioned air from the supply plenum and the respective top half of the cylinder drum being at least partly covered by the return plenum.

6. The process of claim 5, wherein the dried sausage is cooled after it leaves the dryer.

7. The process of claim 6, wherein the dried sausage is frozen after it leaves the dryer.

8. The process of claim 1, wherein the sliced sausage is passed through the dryer in less than a one hour time period.

9. The process of claim 1, wherein the cooked sausage is sliced to a thickness of 5/16″ or less.

10. The process of claim 1, wherein the meat mixture is a pepperoni meat mixture and the dried sausage is pepperoni.

11. A process for making sliced pepperoni, the process comprising the steps of:
blending a pepperoni meat mixture with water, salt, culture and seasonings, and either placing the mixture in casings or extruding the blended meat mixture into sheets, fermenting and cooking the resulting sausage, cooling the cooked sausage, slicing the cooled sausage and feeding the sliced sausage to a drum dryer, the drum dryer having perforated sidewalls and an associated drive mechanism for rotating the drum dryer about a generally horizontal axis, the dryer having a generally cylindrical exterior and an interior and a plurality of air vents associated with the dryer which cause the slices to rise, fall and tumble within the dryer interior between an entrance point and an exit point thereof, and drying the sausage to a moisture to protein ratio of 1.6:1 or less in less than one hour by contacting the sliced sausage with conditioned air supplied by the vents in the enclosure, and wherein the sausage enters the dryer interior at one end thereof and exits at an opposite end thereof, the conditioned air entering a lower portion of the dryer interior through the perforated sidewalls thereof and exiting a top portion thereof, such that the sausage is moved by air from the entrance point to the exit point of the dryer interior.

12. The process claim 11, wherein the drum dryer air ducts are arranged as a part of a lower supply plenum and an upper return plenum, a bottom half of the cylinder drum being exposed to conditioned air from the supply plenum and the respective top half of the cylinder drum being at least partly covered by the return plenum.

13. The process of claim 12, further comprising the steps of passing the sliced pepperoni to a cooling stage for reducing the temperature of the dried, sliced sausage after it leaves the perforated drum dryer.

14. The process of claim 11, wherein the supply plenum which supplies conditioned air to the interior of the drum dryer is divided longitudinally into at least a first and second treatment zones, and wherein the first zone introduces air at a temperature less than about 40° F. and humidity of about 20% and the second zone introduces air at a temperature of less than about 70° F. and humidity of about 10%.
